(19) United States
(12) Patent Application Publication
(10) Pub. No.: US 2025/0302056 A1
(43) Pub. Date: Oct. 2, 2025

(54) STUN BOX SIMULATOR

(71) Applicant: National Beef Packing Company, LLC, Kansas City, MO (US)

(72) Inventors: Colton Horn, Tyrone, OK (US); Anthony Nichols, Rapid River, MI (US)

(21) Appl. No.: 19/096,670

(22) Filed: Mar. 31, 2025

Related U.S. Application Data
(60) Provisional application No. 63/572,346, filed on Mar. 31, 2024.

(51) Int. Cl. A22B 3/06; G09B 25/02

(52) U.S. Cl. CPC A22B 3/06; G09B 25/02

(57) ABSTRACT

Implementations extend to a stun box simulator and related methods of simulating a production stun box. The stun box simulator can be configured to provide a realistic hands-on training experience for a user-trainee learning how to effectively stun an animal prior to slaughter. In one implementation, a stun box simulator includes a slide vertically slidable on a post. The stun box simulator further includes a coupler attached to the slide and mechanically connected to a receiver with a cow head mounted thereon. The stun box simulator can also feature one or more pistons that facilitate moving the cow head vertically and/or horizontally, as well as one or more springs that provide additional variability and/or unpredictability in movements of the cow head.

### CROSS-REFERENCE TO RELATED APPLICATIONS

This application claims the benefit of U.S. Provisional Patent Application No. 63/572,346, entitled “Stun Box Simulator,” filed Mar. 31, 2024, which is incorporated by reference herein in its entirety.

### BACKGROUND

### 1. Field of the Invention

The invention relates to the field of commercial meat production and, more particularly, to a stun box simulator.

### 2. Background and Relevant Art

During commercial meat production, a beef carcass is subjected to a number of different procedures. The animal is first slaughtered, its hide is removed from the carcass, and the carcass is washed. The carcass may also be steam pasteurized, and the carcass may also be subjected to an electrical stimulation process. During commercial meat production, the carcass may be attached to a trolley or shackle at different points in the meat processing line. The carcass then travels along the meat processing line and is subjected to a number of processes, including weighing of the carcass and removal of some portions of the carcass. The carcasses are also inspected at a number of locations along the meat processing line, and certain information regarding carcasses may be recorded at the inspection locations. In addition, portions of the carcass that have been removed, such as the viscera, may be inspected to ensure that the animal was healthy at the time of slaughter.

Humane handling and slaughter practices for livestock cause a minimum of excitement, pain, injury, or discomfort to the livestock. The Humane Methods of Slaughter Act of 1978 (HMSA) makes mandatory the humane slaughter and handling of livestock (including cattle and calves) in connection with slaughter of all food animals slaughtered in United States Department of Agriculture (USDA) inspected establishments. One method determined to be humane requires rendering livestock insensible to pain on the first application of a stunning device before being shackled, hoisted, cast, or cut (7 U.S.C. § 1902). Common stunning devices include captive bolt instruments (also known as captive bolt pistols, captive bolt guns, cattle guns, stunbolt guns, bolt guns, stun guns, stunners, etc.). Common types of captive bolt instruments can be cartridge fired or pneumatic.

A stunning box (sometimes referred to as a “knock box”) can be utilized to move an animal into position for stunning. A stunning box can be narrow enough to prevent an animal from turning around and include a non-slip floor so an animal can stand without losing footing. A single animal should be placed in a stunning box at a time to prevent trampling. Different stunning box designs can be utilized to appropriately orient an animal's head prior to stunning. When an animal is appropriately positioned, a human can detonate (activate) a captive bolt instrument to stun the animal.

In general, the Code of Federal Regulations further defines that captive bolt stunners shall be applied to livestock so as to produce immediate unconsciousness before further processing (9 C.F.R. § 313.15). Acceptable captive bolt stunning instruments can be nonpenetrating (concussion or mushroom type stunners) or penetrating (9 C.F.R. § 313.15(b)).

On detonation, nonpenetrating or mushroom stunning instruments deliver a bolt with a flattened circular head against the external surface of the animal's head over the brain. Diameter of the striking surface of the stunner may vary as conditions require. Unconsciousness is produced immediately by a combination of acceleration concussion and changes in intracranial pressures. Nonpenetrating captive bolt stunning typically requires more precise aiming. Accordingly, a stunning box can include head holders when nonpenetrating captive bolt instruments are utilized for stunning.

On detonation, penetrating stunning instruments deliver bolts of varying diameters and length into the brain. Unconsciousness is produced by physical brain destruction and a combination of changes in intracranial pressure and acceleration concussion.

A combination instrument utilizing both penetrating and nonpenetrating principles is acceptable. Energizing of instruments may be accomplished by detonation of measured charges of gunpowder or accurately controlled compressed air (pneumatic). Captive bolts shall be of such size and design that, when properly positioned and activated, immediate unconsciousness is produced.

The stunning procedure is an exacting procedure and requires well-trained and experienced operators. An operator must be able to accurately place the stunning instrument to produce immediate unconsciousness. The operator must use the correct detonating charge with regard to kind, breed, size, age, and sex of an animal to produce the desired results.

Failure to effectively stun an animal in one attempt can result in a USDA violation and can include Regulatory Control Action (RCA), such as retention of product, rejection of equipment or facilities, slowing or stopping of lines, or refusal to allowed processing (9 C.F.R. § 500.1(a)). If inhumane treatment is caused as the result of improper stunning, an inspector shall attach a “U.S. Rejected” tag to the stunning area. Stunning procedures shall not be resumed until the inspector receives satisfactory assurances from the establishment operator that there will not be a recurrence. The tag shall not be removed by anyone other than an inspector.

The USDA defines “unconscious” as not awake or aware to respond to stimuli or environment. The USDA equates unconscious and insensible. The USDA defines “conscious” as awake or aware and able to respond to stimuli and environment. The USDA equates conscious and sensible. An “effective” stun successfully makes and keeps an animal unconscious throughout shackling, sticking, and bleeding. (see Food Safety and Inspection Service (FSIS) Directive 6900.2, Revision 3, and FSIS “Humane Handling: Consciousness and Stunning” Training). An “ineffective” stun attempt is a stunning attempt that contacts an animal but does not make the animal unconscious.

Missing an animal by not making contact is not considered a stunning attempt. However, missing an animal may be considered in the event of an ineffective stun followed by a missed attempt when determining egregious status. A security stun (or safety stun, assurance stun, or double stun) is an extra stun on an animal that was already rendered insensible in a first stun attempt. If an animal remains conscious after a first stun attempt, the next stun attempt is not a security stun.

Immediate, effective corrective action upon a miss includes a plant employee instantly making an ineffectively stunned animal unconscious with an available back-up stunning device (without hesitation or being instructed).

Multiple ineffective stun attempts (2 or more) may be considered egregious non-compliance with humane handling resulting in a Notice of Suspension (NOS) or Notice of Intended Enforcement (NOIE) for an employee. Establishments with one or more instances of noncompliance, whether egregious or non-egregious, can be subject to USDA sanctions, including fines.

Employees that operate captive bolt instruments are sometimes referred to as “knockers” and they are responsible for rendering cattle insensible as they enter beef facilities for processing. As described, if there is a problem with a stun or “knock”, a facility can be temporarily slowed or shut down. As cattle and humans are both living, breathing beings, perfection isn't always possible.

For example, when a knocker responds to an ineffective first stun attempt, they may react too quickly. The knocker may not take the time to see an animal's head moving and/or may not take time (e.g., four to five seconds) to calm the animal. Without observing movement and/or calming the animal, the chance of a second ineffective stun increases. A second ineffective stun is a USDA violation.

In view of this background and the relevant art, it would therefore be useful to provide new and improved stun box methods, systems, and apparatuses as further described herein.

### BRIEF SUMMARY

Examples extend to methods, systems, apparatuses, and computer program products for stun box simulators.

Aspects include a stun box simulator that mimics a real production stun box by providing a cow head (real or prosthetic) mounted and movable on a receiver to approximate the head movements of a live animal. A human user-trainee can then employ a captive bolt instrument on the cow head in the stun box simulator to learn and practice in preparation of performing effective stunning on a live animal in a production stun box environment.

Other aspects include various ways in which a stun box simulator facilitates movement of a mounted cow head. In some implementations, movement of a mounted cow head within a stun box simulator is accomplished and controlled manually by using handles. Thus, an operator-trainer can use the handles to move the mounted cow head in a manner that simulates a live animal. In other implementations, movement of a mounted cow head within a stun box simulator is accomplished and controlled mechanically by using pistons powered pneumatically, hydraulically, or electrically. Thus, an operator-trainer can use a control panel connected to the pistons to move the mounted cow head in a way that approximates a live animal. In even other implementations, movement of a mounted cow head within a stun box simulator is controlled by a computer program running on a computing device connected to the pistons (e.g., pneumatic, hydraulic, or electric pistons). Thus, a computing device connected to the pistons can move the mounted cow head according to a computer program in order to imitate a live animal.

Additional aspects include a stun box simulator that includes one or more springs attached to a receiver upon which a cow head (real or prosthetic) is mounted. The springs can store and release mechanical energy during piston movements. The storage and release of mechanical energy by the one or more springs can cause additional variability and/or unpredictability in movements of the mounted cow head.

Other additional aspects include a stun box simulator that approximates the dimensions, flooring, and side walls of a production stun box.

One implementation pertains to a stun box simulator featuring a post, a slide vertically slidable on the post, the slide including a ball on top, a receiver, a coupler mechanically connected to the receiver, the coupler including a ball socket attached to the ball, and a cow head mounted on the receiver. The stun box simulator may further feature pistons connected to the slide and/or the receiver, as well as one or more springs connected to the receiver.

Another implementation relates to a stun box simulator featuring a floor, a post mounted to the floor, a slide vertically slidable on the post, the slide including a ball on top, a receiver, a coupler mechanically connected to the receiver, the coupler including a ball socket attached to the ball, a cow head mounted on the receiver, and a first piston mounted to the floor and mechanically connected to the slide. The stun box simulator may further feature pistons connected or in contact with the receiver and/or a plate secured to the slide. The stun box simulator may also further feature one or more springs attached to the sides of the receiver and/or underneath the receiver.

An additional implementation concerns a method of simulating a production stun box that includes the steps of mounting a cow head, moving the cow head vertically, and moving the cow head horizontally.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered limiting of its scope, implementations will be described and explained with additional specificity and detail through the use of the accompanying drawings briefly described below.

FIG. 1A illustrates an example exploded view of a stun box simulator in accordance with one or more implementations.

FIG. 1B illustrates an example assembled view of the stun box simulator of FIG. 1A.

FIG. 1C illustrates an example view of the stun box simulator of FIGS. 1A and 1B with the addition of another side wall and crossbars.

FIG. 2A illustrates an example view of the front of a stun box simulator having handle assemblies in accordance with one or more implementations.

FIG. 2B illustrates an example view of the rear of the stun box simulator of FIG. 2A.

FIG. 2C illustrates another example view of the front of the stun box simulator of FIG. 2A.

FIG. 2D illustrates another example view of the rear of the stun box simulator of FIG. 2A.

FIG. 2E illustrates an example view of the front of the stun box simulator of FIG. 2A with the addition of another side wall and crossbars.

FIG. 3A illustrates an example view of the top of a receiver and a coupler of a stun box simulator in accordance with one or more implementations.

FIG. 3B illustrates an example view of the side of the receiver and the coupler of the stun box simulator of FIG. 3A.

FIG. 3C illustrates an example view of the front of the receiver and the coupler of the stun box simulator of FIG. 3A with the addition of a front piston.

FIG. 3D illustrates an example view of the rear of the receiver and the coupler of the stun box simulator of FIG. 3A.

FIG. 3E illustrates an example view of the rear of the stun box simulator of FIG. 3A.

FIG. 3F illustrates an example view of the side of the stun box simulator of FIG. 3A.

FIG. 4A illustrates an example view of the front of a stun box simulator in accordance with one or more implementations.

FIG. 4B illustrates an example view of the rear of the stun box simulator of FIG. 4A.

FIG. 4C illustrates an example view of the front of the stun box simulator of FIG. 4A with the addition of a cow head.

FIG. 5 illustrates an example view of the rear of a stun box simulator having a control panel and a window in accordance with one or more implementations.

FIG. 6 illustrates an example view of the front of a stun box simulator operated by an operator-trainer and used by a user-trainee employing a captive bolt instrument on a mounted cow head.

FIG. 7 illustrates a flowchart of a series of acts in a method of simulating a production stun box in accordance with one or more implementations.

FIG. 8 illustrates a schematic block diagram of an exemplary computing device in accordance with one or more implementations.

### DETAILED DESCRIPTION

Examples extend to methods, systems, apparatuses, and computer program products for stun box simulators. In general, a stun box (which may also be referred to as a “knock box”) simulator for a facility can be configured similar to a production stun box at the facility. For example, a stun box simulator for a facility can be constructed to have internal and external dimensions, cattle restraints, flooring, and a captive bolt instrument that are similar, if not essentially identical, to a production stun box at the facility.

A cow head or prosthetic cow head can be mounted on a receiver (e.g., built around ball-and-socket movement of a trailer hitch) inside the stun box simulator. In one aspect, the receiver is connected (e.g., via connecting rods) to one or more handles that extend outside the stun box simulator. A human operator-trainer can move the handles (e.g., manually or using operating pedals) to tailor movement of the mounted cow head or mounted prosthetic cow head in a way that approximates movements of a live cow in a production stun box.

In another aspect, the receiver is connected to one or more pistons (e.g., directly or via connecting rods) inside the stun box simulator. More particularly, the stun box simulator may include (e.g., contain) one, two, or three pistons. A piston can be a pneumatic or hydraulic piston. Each piston can be controlled by one or more of: pneumatic, hydraulic, electrical, or digital control components to move the mounted cow head in one-dimension, two-dimensions, or three-dimensions. The pistons can be operated, controlled, programmed, etc. to tailor movement of the mounted cow head or mounted prosthetic cow head in a way that approximates movements of a live cow in a production stun box.

A control panel or computer system can be connected to the one or more pistons. A human operator-trainer can utilize the control panel or computer system (e.g., with operating pedals or a pneumatic joystick) to operate/control the pistons. Alternatively, and/or in combination, a program is executed at the control panel or computer system. The program operates/controls the one or more pistons automatically.

In further implementations, a combination of handles and pistons are utilized. A human operator-trainer can control the combination of handles and pistons manually or through a controller or computer system. Alternatively, and/or in combination, a program is executed at the control panel or computer system. The program operates/controls the handles and pistons automatically. The pistons and handles can be operated, controlled, programmed, etc. to tailor movement of the mounted cow head or mounted prosthetic cow head in a way that approximates movements of a live cow in a production stun box.

A human user-trainee can detonate the captive bolt instrument into the cow head or prosthetic cow head inside the stun box simulator during the approximated live cow movements. As such, the operator-trainer can evaluate the user-trainee's use of the captive bolt instrument in an environment that simulates, but does not include, a live animal. A human user-trainee may be a person learning to be a “knocker” or may be a “knocker” receiving remedial training due to a USDA violation when working at a production stun box.

As such, a physical knocking “dummy” that approximates movements and responses of a live animal can be used to simulate a live animal. The knocking dummy can be moved in three-dimensions making movements less predictable for a user-trainee. The physical knocking dummy provides knocking user-trainees (or knockers in remediation) a chance to test theoretical knowledge in a more hands-on way.

Different scenarios can be tested using a stun box simulator, including proper captive bolt instrument placement and response to an ineffective stun attempt. In one aspect, a program is executed at a controller or computer system to automate simulation of a desired scenario.

A stun box simulator can be located within proximity of production stun boxes at a beef processing facility. Locating a stun box simulator near production stun boxes can increase training effectiveness due to sounds, smells, etc. of production cattle stunning being heard, smelled, and otherwise experienced by a user-trainee.

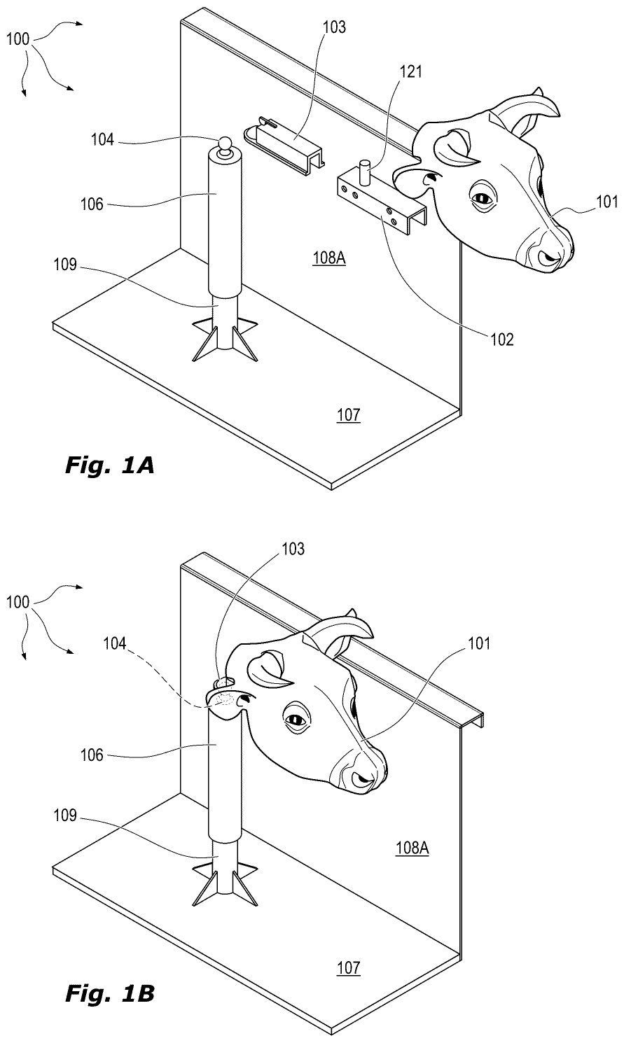

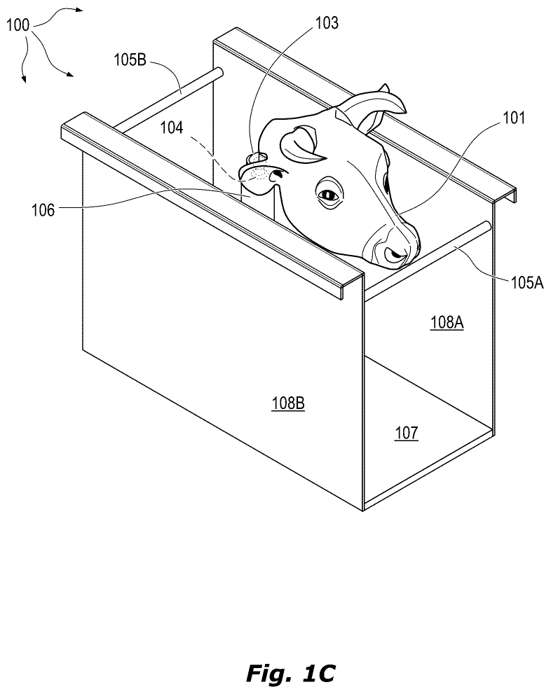

FIGS. 1A, 1B, and 1C depict various views of an example stun box simulator 100.

As depicted in FIGS. 1A and 1B, stun box simulator 100 includes cow head 101 (e.g., a real cow head or a prosthetic cow head), receiver 102, coupler 103, ball 104, slide 106, floor 107, side wall 108A, and post 109. Receiver 102 further includes receiver post 121. Cow head 101 can be mounted on receiver 102. Receiver post 121 helps support cow head 101 on receiver 102. Receiver 102 can be joined to coupler 103. Coupler 103 can include a ball socket configured to mate and secure to ball 104. Pins or screws (not shown) can be used to mechanically secure receiver 102 to coupler 103. As such, cow head 101, receiver 102, and coupler 103 form a sub-assembly.

Ball 104 is mechanically attached to the top of slide 106, which can slide vertically along post 109. As depicted, slide 106 is in a lowered position resting on the top of post 109. Slide 106 can be raised and/or lowered vertically between the lowered position and appropriate heights. Raising and/or lowering slide 106 correspondingly raises and/or lowers ball 104. A stopper internal to post 109 (not shown) may prevent slide 106 from being fully removed from post 109 vertically.

The sub-assembly of 101, 102, and 103 can be mounted (and mechanically attached/secured) to ball 104. In one aspect, coupler 103 and ball 104 are complementary trailer hitch components. When the sub-assembly of 101, 102, and 103 is mounted to ball 104, slide 106 can be moved vertically to raise and/or lower cow head 101. Raising and/or lowering cow head 101 can, to some extent, approximate movements of a live animal in a production stun box.

A handle (not shown) can connect to slide 106 and extend outside side wall 108A. An operator-trainer can use the handle to raise and/or lower slide 106 and thus correspondingly raise and/or lower cow head 101. In one aspect, the handle can be raised and/or lowered manually. In another aspect, the handle can be raised and/or lowered with the assistance of mechanical, electrical, hydraulic, and/or pneumatic components, etc. such as, for example, a programmable lift arm or piston. An operator-trainer can control the lift arm or piston using a corresponding controller such as a joystick or foot pedal. Alternatively, a computer can run a program to control the programmable lift arm or piston.

A captive bolt instrument can also be located in the proximity of stun box simulator 100. A user-trainee can use the captive bolt instrument. The user-trainee can attempt to detonate the captive bolt instrument into the appropriate location on cow head 101 to simulate an effective stun. The user-trainee may attempt detonation while cow head 101 is stationary or while cow head 101 is moving vertically (up/down).

When stationary, cow head 101 may be in a position relatively similar to the head of a live animal in a production stun box. A user-trainee can attempt to detonate the captive bolt instrument into an appropriate location on stationary cow head 101. Operating the captive bolt instrument on stationary cow head 101 provides a hands-on training experience for the user-trainee.

Cow head 101 can be moved vertically simulating, at least to some extent, possible movements of a live animal at a production stun box. A user-trainee can attempt to detonate the captive bolt instrument into the appropriate location on cow head 101 during movement of cow head 101. Operating the captive bolt instrument on a moving cow head 101 provides a more realistic hands-on training experience for the user-trainee.

In one aspect, a spring can be mechanically attached to or near to receiving post 121. The spring may cause additional, and/or more unpredictable, movements of cow head 101. These additional, and more unpredictable, movements can approximate movements of a live animal in a production stun box with somewhat increased accuracy. Operating the captive bolt instrument on a cow head 101 moving with increased unpredictability provides an even more realistic hands-on training experience for the user-trainee.

Turning to FIG. 1C, the dimensions of floor 107 and side walls 108A and 108B can at least approximate, if not essentially match, those of a production stun box. For example, stun box simulator 100 can be placed in a production beef processing facility. The dimensions of floor 107 and side walls 108A and 108B can be essentially the same as the dimensions of production stun boxes at the beef processing facility. Further, the materials used to construct and/or treat floor 107 and side walls 108A and 108B can at least approximate, if not essentially match, those of production stun boxes at the facility. As such, a user-trainee is provided a more realistic training experience when using stun box simulator 100.

Additionally, as FIG. 1C depicts, stun box simulator 100 includes crossbars 105A and 105B. Crossbar 105A connects side wall 108A to side wall 108B toward the front of stun box simulator 100, while crossbar 105B connects side wall 108A to side wall 108B toward the rear of stun box simulator 100. Crossbars 105A and 105B provide added rigidity to stun box simulator 100.

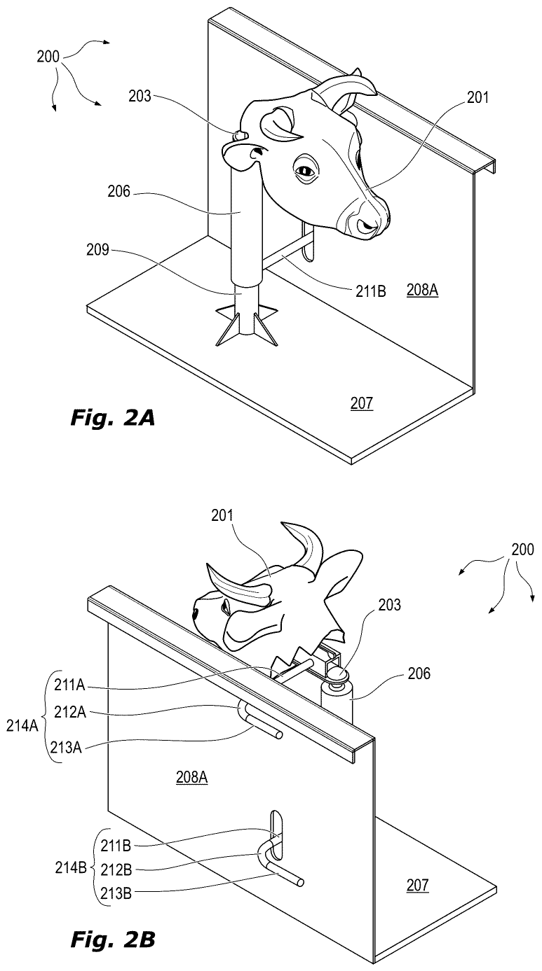

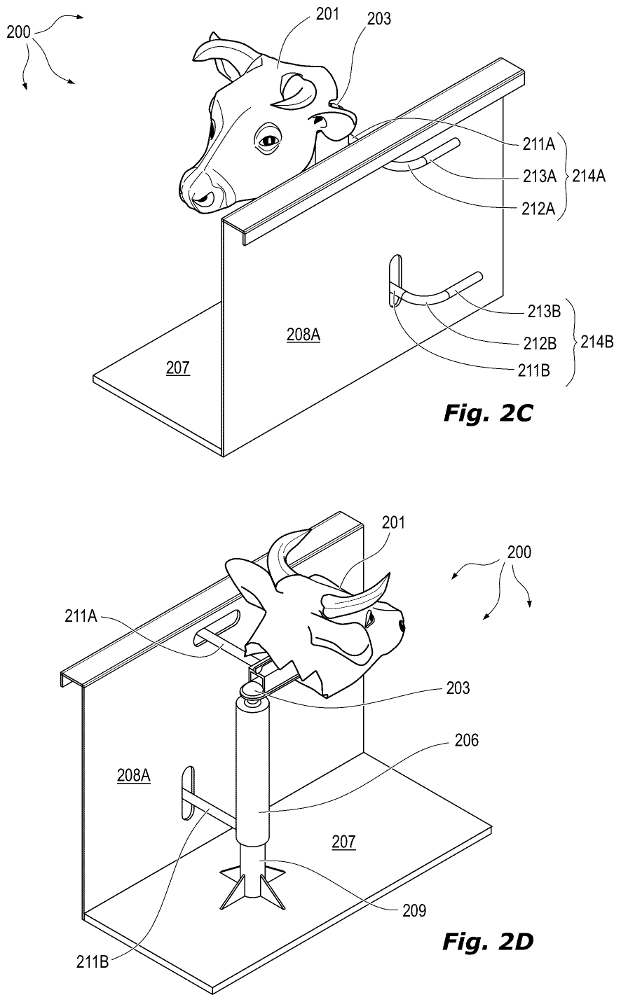

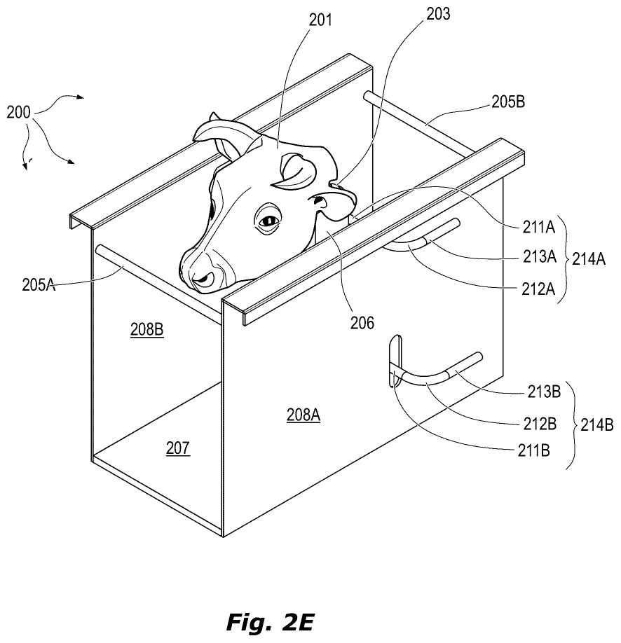

FIGS. 2A, 2B, 2C, 2D, and 2E depict various views of an example stun box simulator 200.

As depicted in FIGS. 2A, 2B, 2C, and 2D, stun box simulator 200 includes cow head 201 (e.g., a real cow head or a prosthetic cow head), a receiver (covered by cow head 201), coupler 203, a ball (similar to 104 and covered by coupler 203), slide 206, floor 207, side wall 208A, post 209, handle assembly 214A, and handle assembly 214B. Coupler 203 can include a ball socket configured to mate and secure to the ball at the top of slide 206. The receiver further includes a receiver post (similar to receiver post 121 and also covered by cow head 201).

Cow head 201 can be mounted on the receiver. The receiver post helps support cow head 201 on the receiver. The receiver can be joined to coupler 203. Pins or screws (not shown) can be used to mechanically secure the receiver to coupler 203. As such, cow head 201, the receiver, and coupler 203 form a sub-assembly. The sub-assembly of cow head 201, the receiver, and coupler 203 can be mounted (and mechanically attached/secured) to the ball. In one aspect, coupler 203 and the ball are complementary trailer hitch components.

In general, when the sub-assembly of cow head 201, the receiver, and coupler 203 is mounted to the ball, handle assemblies 214A and 214B can be utilized to move cow head 201. Movement of cow head 201 can, at least to some extent, approximate movements of a live animal in a production stun box.

Handle assembly 214A includes connecting rod portion 211A, curved rod portion 212A, and handle rod portion 213A. One end of connecting rod portion 211A is mechanically connected/secured to coupler 203. Connecting rod portion 211A extends outside of side wall 208A. The other end of connecting rod portion 211A is mechanically connected/secured to an end of curved rod portion 212A. In one aspect, curved rod portion 212A is curved at approximately a 90-degree angle. The other end of curved rod portion 212A is connected to an end of handle rod portion 213A. Handle rod portion 213A can be moved.

Force applied to handle rod portion 213A transfers through curved rod portion 212A and connecting rod portion 211A to move coupler 203 and correspondingly move cow head 201. Thus, handle rod portion 213A can be utilized to move cow head 201 inside stun box simulator 200. Pulling handle rod portion 213A (away from side wall 208A) causes coupler 203 (and thus also cow head 201) to rotate toward side wall 208A. Conversely, pushing handle rod portion 213 (toward side wall 208A) causes coupler 203 (and thus also cow head 201) to rotate away from side wall 208A.

Handle assembly 214B includes connecting rod portion 211B, curved rod portion 212B, and handle rod portion 213B. One end of connecting rod portion 211B is mechanically connected/secured to slide 206. Connecting rod portion 211B extends outside of side wall 208A. The other end of connecting rod portion 211B is mechanically connected/secured to an end of curved rod portion 212B. In one aspect, curved rod portion 212B is curved at approximately a 90-degree angle. The other end of curved rod portion 212B is connected to an end of handle rod portion 213B. Handle rod portion 213B can be moved.

Force applied to handle rod portion 213B transfers through curved rod portion 212B and connecting rod portion 211B to slide 206 and thus moves cow head 201. Thus, handle rod portion 213B can be utilized to move cow head 201 inside stun box simulator 200. Raising handle rod portion 213B up causes slide 206 (and thus also cow head 201) to raise up. Lowering handle rod portion 213B down causes slide 206 (and thus also cow head 201) to lower down.

An operator-trainer can use handle assembly 214A to rotate or otherwise move cow head 201 about the ball and ball socket connection of coupler 203. An operator-trainer can also use handle assembly 214B to lower/raise cow head 201 (potentially rotating and lowering/raising simultaneously). In one aspect, handle assembly 214A is pushed and/or pulled manually. In another aspect, handle assembly 214A is pushed and/or pulled with the assistance of mechanical, electrical, hydraulic, and/or pneumatic components, etc. such as, for example, a programmable lift arm or piston. An operator-trainer can control the lift arm or piston using a corresponding controller such as a joystick or foot pedal. Alternatively, a computer can run a program to control the lift arm or piston.

In one aspect, handle assembly 214B is raised and/or lowered manually. In another aspect, handle assembly 214A is raised and/or lowered with the assistance of mechanical, electrical, hydraulic, and/or pneumatic components, etc. such as, for example, a programmable lift arm or piston. An operator-trainer can control the lift arm or piston using a corresponding controller such as a joystick or foot pedal. Alternatively, a computer can run a program to control the lift arm or piston.

A captive bolt instrument can also be located in the proximity of stun box simulator 200. A user-trainee can use the captive bolt instrument. The user-trainee can attempt to detonate the captive bolt instrument into the appropriate location on cow head 201 to simulate an effective stun. The user-trainee may attempt detonation while cow head 201 is being rotated and/or while cow head 201 is moving vertically up or down.

Cow head 201 can (potentially simultaneously) be rotated and/or moved vertically simulating, at least to some extent, possible movements of a live animal at a production stun box. A user-trainee can attempt to detonate the captive bolt instrument into the appropriate location on cow head 201 during rotation and/or vertical movement of cow head 201. Operating the captive bolt instrument on a rotating and/or moving cow head 201 provides a more realistic hands-on training experience for the user-trainee.

In one aspect, a spring can be mechanically attached to, or near to, receiver post 121. The spring may cause additional, and/or more unpredictable, movements of cow head 201. These additional, and more unpredictable, movements can approximate movements of a live animal in a production stun box with somewhat increased accuracy. Using the captive bolt instrument on a cow head 201 that is moving with increased unpredictability provides an even more realistic hands-on training experience for the user-trainee.

Turning to FIG. 2E, the dimensions of floor 207 and side walls 208A and 208B can at least approximate, if not essentially match, those of a production stun box. For example, stun box simulator 200 can be placed in a production beef processing facility. The dimensions of floor 207 and side walls 208A and 208B can be essentially the same as the dimensions of production stun boxes at the beef processing facility. Further, the materials used to construct/treat floor 207 and side walls 208A and 208B can at least approximate, if not essentially match, those of production stun boxes at the beef processing facility. As such, a user-trainee is provided a more realistic training experience when using stun box simulator 200.

Additionally, as FIG. 2E depicts, stun box simulator 200 includes crossbars 205A and 205B. Crossbar 205A connects side wall 208A to side wall 208B toward the front of stun box simulator 200, while crossbar 205B connects side wall 208A to side wall 208B toward the rear of stun box simulator 200. Crossbars 205A and 205B provide added rigidity to stun box simulator 200.

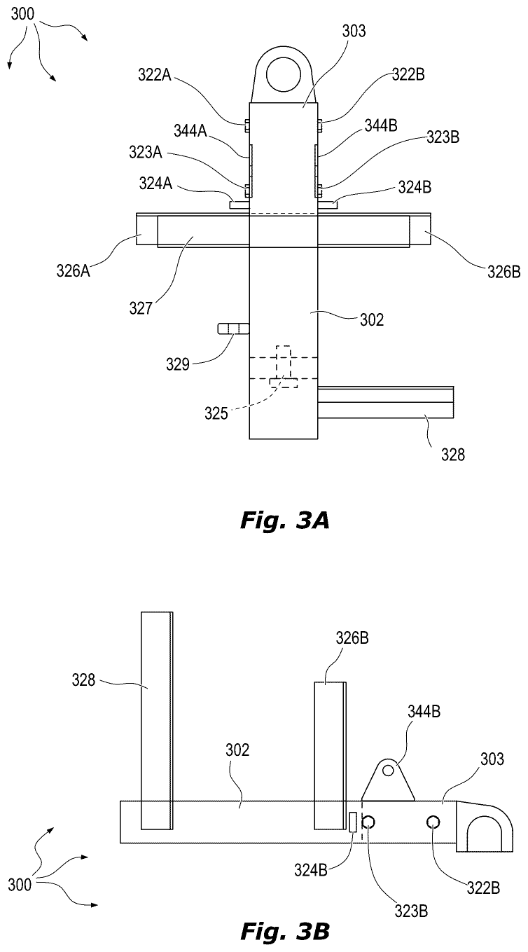

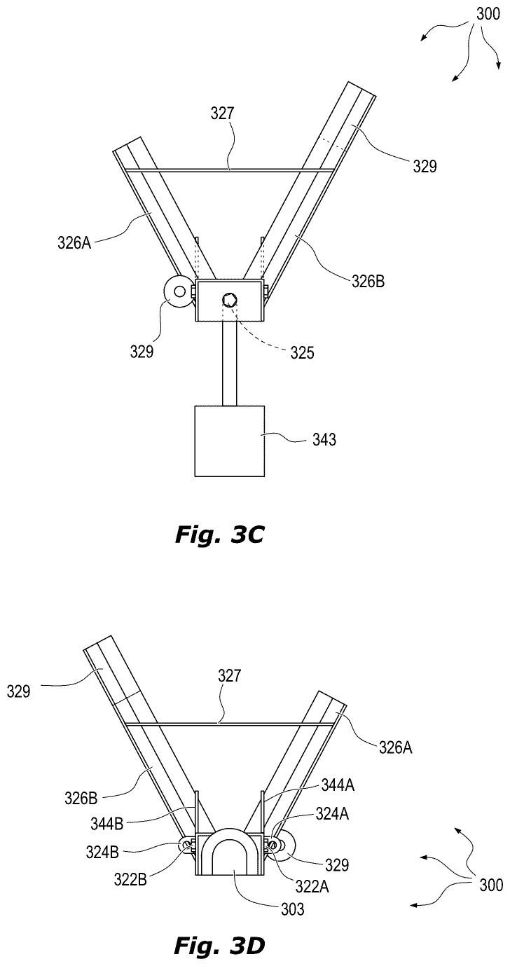

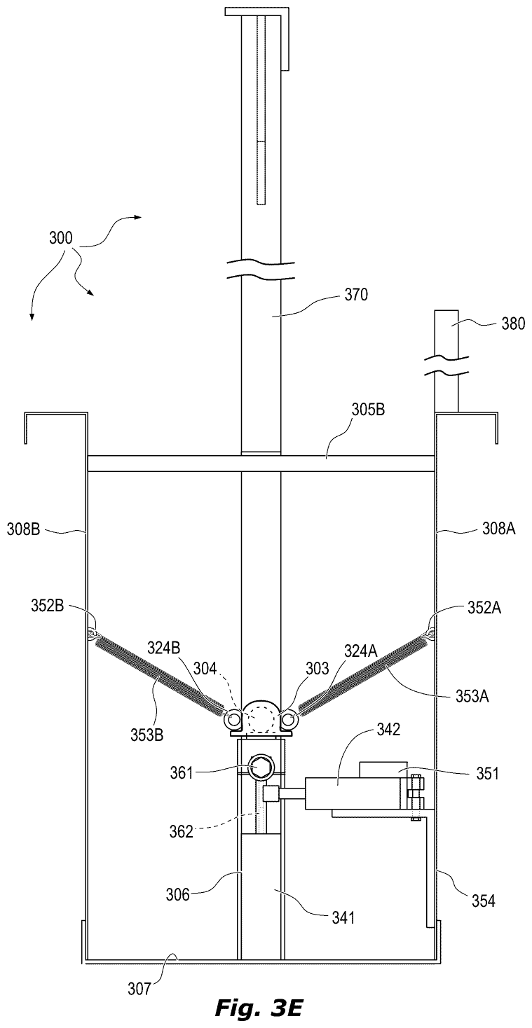

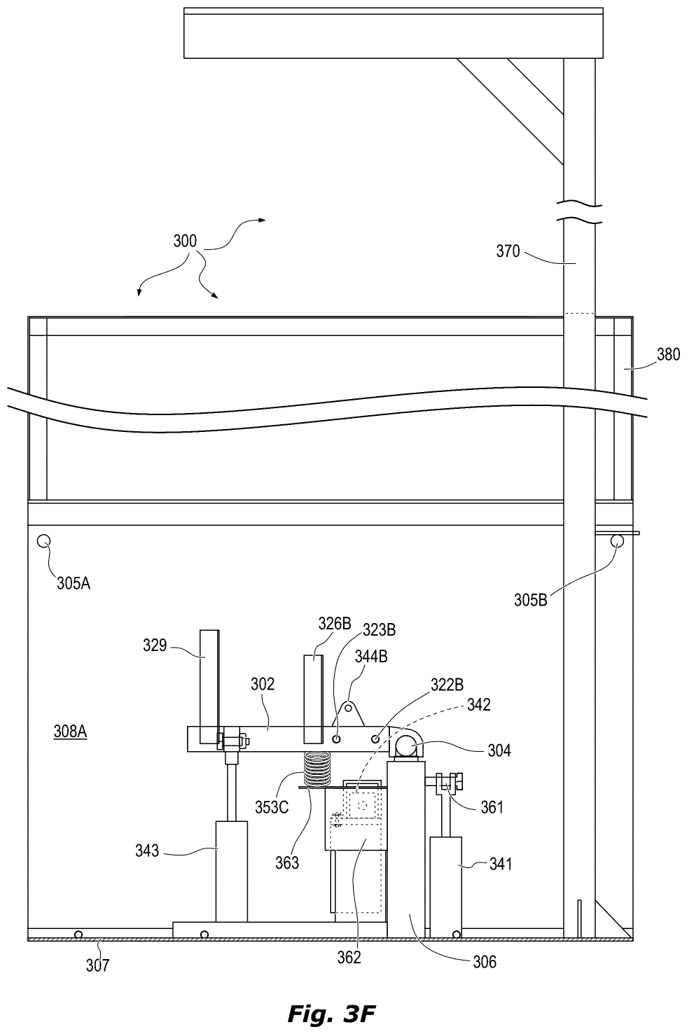

As described, one or more pistons can be used to move a cow head at a stun box simulator. In one aspect, three pistons are contained inside a stun box simulator. FIGS. 3A-3F depict various example views of a stun box simulator 300 in accordance with one or more implementations.

FIG. 3A depicts the top of receiver 302 and coupler 303 of stun box simulator 300, while FIG. 3B depicts the side of receiver 302 and coupler 303 of stun box simulator 300. Further, FIG. 3C depicts the front of receiver 302 and coupler 303 of stun box simulator 300. In contrast, FIG. 3D depicts the rear of receiver 302 and coupler 303 of stun box simulator 300. Moreover, FIG. 3E depicts the rear of stun box simulator 300, while FIG. 3F depicts the side of stun box simulator 300.

As depicted in FIGS. 3A-3D, stun box simulator 300 includes receiver 302, coupler 303, threaded connectors 322A and 322B, threaded connectors 323A and 323B, eyelets 324A and 324B, eyelet tabs 344A and 344B, angle irons 326A and 326B, connecting plate 327, angle iron 328, eyelet 329, front piston 343 (e.g., a pneumatic or hydraulic piston), and post 325. Receiver 302 can be similar to receiver 102 and/or the receiver (not shown) of stun box simulator 200. Coupler 303 can be similar to coupler 103 and/or coupler 203. Threaded connectors 323A and 323B can be used to secure receiver 302 to coupler 303. Front piston 343 can connect to receiver 302 using post 325.

Angle irons 326A, 326B, connecting plate 327, and angle iron 328 provide support for a cow head (real or prosthetic) placed on top of receiver 302 and/or coupler 303. A cow head can slide into the space formed by angle irons 326A, 326B, and connecting plate 327. Angle irons 326A, 326B, connecting plate 327, and angle iron 328 help keep the cow head in place when pistons are moving receiver 302 and/or coupler 303 (e.g., to approximate movement of a live animal). Additionally, eyelet 329 and eyelet tabs 344A and 344B can be used to attach a cow head (real or prosthetic) on top of receiver 302 and/or coupler 303 by connecting one or more straps (e.g., ropes, ratchet straps, bungy cords, etc.) between eyelet 329 and eyelet tabs 344A and 344B. Alternatively, a cow head (real or prosthetic) by can be attached on top of receiver 302 and/or coupler 303 by wrapping one or more straps (e.g., ropes, ratchet straps, bungy cords, etc.) around the cow head and receiver 302 and/or coupler 303.

Eyelets 324A and 324B can be configured to connect springs that are also connected to walls of a stun box simulator.

Turning to FIG. 3E, stun box simulator 300 further includes ball 304, floor 307, slide 306 (mounted on a post similar to post 109 and/or post 209), side walls 308A and 308B, eyelets 352A and 352B, springs 353A and 353B, rear piston 341 (e.g., a pneumatic or hydraulic piston), side piston 342 (e.g., a pneumatic or hydraulic piston), piston holder 351, and piston support plate 354. Coupler 303 can include a ball socket configured to mate and secure to ball 304. One end of spring 353A can be connected to eyelet 352A and the other end of spring 353A connected to eyelet 324A. Similarly, one end of spring 353B can be connected to eyelet 352B and the other end of spring 353B connected to eyelet 324B.

Turning to FIG. 3F, stun box simulator 300 also includes spring 351, post 361, plate 362, and plate 363. Post 361 can extend perpendicularly from and be mechanically secured (e.g., welded) to slide 306. Plate 362 can also extend perpendicularly from and be mechanically secured (e.g., welded) to slide 306.

Rear piston 341 can be mounted to floor 307 and in mechanical contact with post 361. Rear piston 341 can be raised to raise slide 306 by raising post 361 (and in turn raise the rear portion of a mounted cow head). Rear piston 341 can be lowered to lower slide 306 by lowering post 361 (and in turn lower the rear portion of a mounted cow head).

Side piston 342 can be secured in side piston holder 351 (which is mounted to side wall 308A) and in mechanical contact with plate 362. Plate 362 provides a surface for side piston 342 to interact against. Side piston 342 can be extended to push against plate 362 and rotate or provide a lateral side-to-side movement of slide 306 (and in turn rotate or provide a lateral side-to-side movement of a mounted cow head) in one direction. Side piston 342 can be retracted to pull against plate 362 and rotate or provide a lateral side-to-side movement of slide 306 (and in turn rotate or provide a lateral side-to-side movement of a mounted cow head) in another direction.

Front piston 343 can be secured to and in mechanical contact with a front portion of receiver 302, such as post 325. Front piston 343 can be raised to raise the front portion of receiver 302 (and in turn raise the front portion of a mounted cow head). Front piston 343 can be lowered to lower the front portion of receiver 302 (and in turn lower the front portion of a mounted cow head). Rear piston 341 can be raised to raise the rear portion of receiver 302 (and in turn raise the rear portion of a mounted cow head). Rear piston 341 can be lowered to lower the rear portion of receiver 302 (and in turn lower the rear portion of a mounted cow head).

As FIGS. 3E and 3F depict, springs 353A, 353B, and 353C can store mechanical energy when an opposing force is applied and release mechanical energy when the opposing force is removed.

An operator-trainer can use rear piston 341, side piston 342, and front piston 343 to move a mounted cow head (real or prosthetic). Rear piston 341, side piston 342, and front piston 343 can be utilized to simultaneously raise/lower the rear portion and front portion of a mounted cow head and rotate or move side-to-side the mounted cow head. Springs 353A, 353B, and 353C can store and release mechanical energy during piston movements. The storage and release of mechanical energy by springs 353A, 353B, and 353C can cause additional variability and/or unpredictability in movements of a mounted cow head. An operator-trainer can control rear piston 341, side piston 342, and front piston 343 using a corresponding controller such as a joystick or foot pedal. Alternatively, a computer can run a program to control rear piston 341, side piston 342, and front piston 343.

A captive bolt instrument can also be located in the proximity of stun box simulator 300. A user-trainee can use the captive bolt instrument. The user-trainee can attempt to detonate the captive bolt instrument into the appropriate location on a mounted cow head (real or prosthetic) to simulate an effective stun. The user-trainee may attempt detonation while the mounted cow head is being rotated or otherwise moving horizontally and/or while different portions of the mounted cow head are moving vertically.

A mounted cow head can (potentially simultaneously) be rotated or moved horizontally and/or different portions moved vertically thereby simulating, at least to some extent, possible movements of a live animal at a production stun box. A user-trainee can attempt to detonate the captive bolt instrument into the appropriate location on a mounted cow head during rotation, horizontal movement, and/or vertical movement of cow head. Operating the captive bolt instrument on such a moving cow head provides a more realistic hands-on training experience for the user-trainee.

In one aspect, rear piston 341, side piston 342, and front piston 343 are utilized concurrently while springs 353A, 353B, and 353C are also concurrently storing and releasing mechanical energy. Collectively, the resulting movements of a mounted cow head can approximate movements of a live animal in a production stun box with even more increased accuracy (e.g., relative to stun box simulators 100 and 200). Operating the captive bolt instrument on a cow head (real or prosthetic) that is moving in stun box simulator 300 further enhances realism of hands-on training experiences for user-trainees (e.g., relative to stun box simulators 100 and 200).

The dimensions of floor 307 and side walls 308A and 308B can at least approximate, if not essentially match, those of a production stun box. For example, stun box simulator 300 can be placed in a production beef processing facility. The dimensions of floor 307 and side walls 308A and 308B can be essentially the same as the dimensions of production stun boxes at the beef processing facility. Further, the materials used to construct/treat floor 307 and side walls 308A and 308B can at least approximate, if not essentially match, those of production stun boxes at the beef processing facility. As such, a user-trainee is provided a more realistic training experience when using stun box simulator 300.

FIGS. 3E and 3F also depict stun box simulator 300 includes vertical support 370 from which a captive bolt instrument can be hung. Additionally, FIG. 3F depicts stun box simulator 300 includes a window 380 connected to side wall 308A to protect an operator-trainer during operation of stun box simulator 300.

Aspects of the invention have been described with respect to beef processing. However, aspects of the invention are not in any way limited. Stun box simulators can be configured for training knockers to stun (or knock) a variety of livestock animal types including sheep, swine, goats, calves, cattle, horses, mules, other equines, etc.

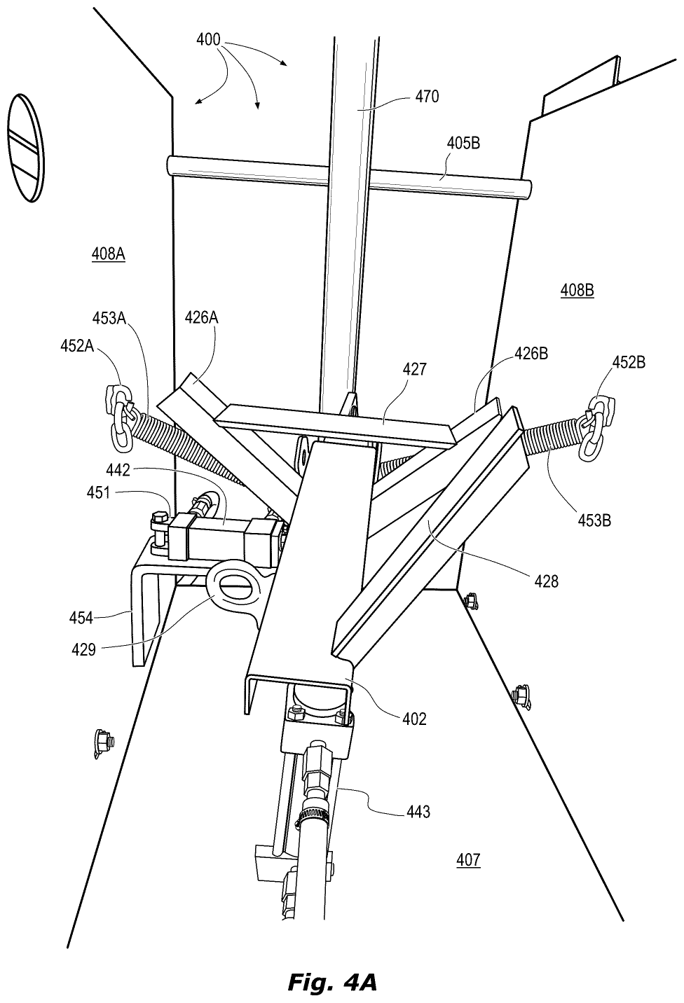

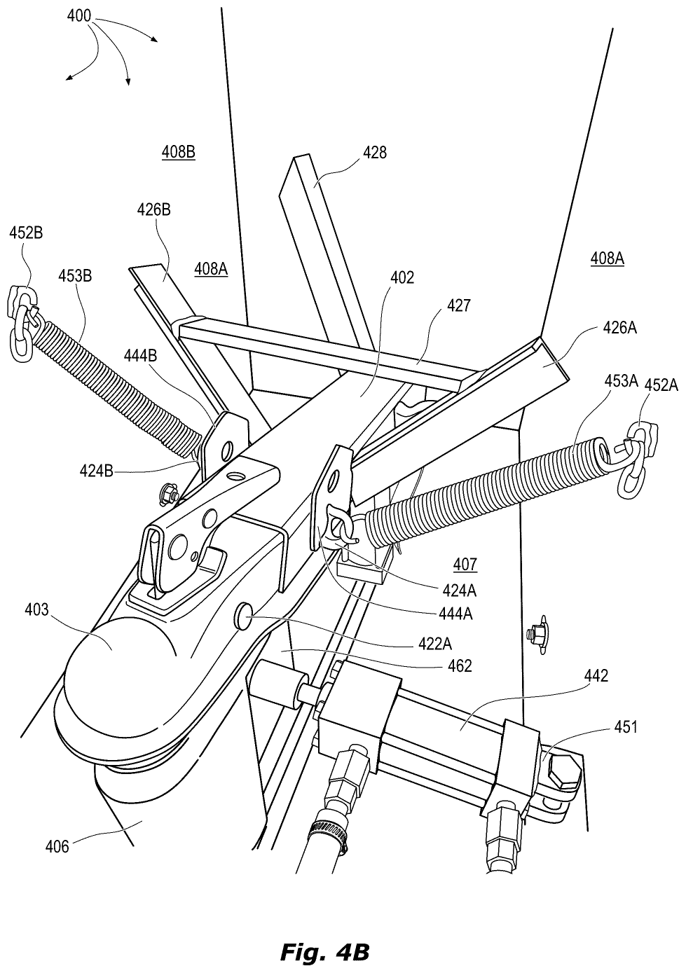

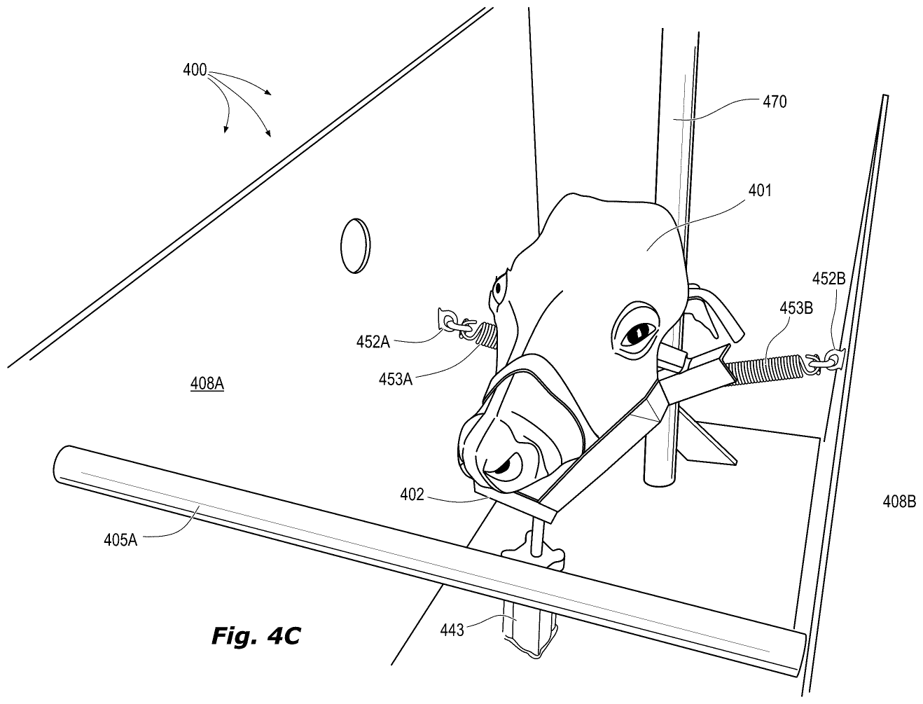

FIGS. 4A-4C depict various views of a stun box simulator 400. More specifically, FIG. 4A depicts an example view of the front of a stun box simulator 400 in accordance with one or more implementations, such as a stun box simulator prototype. As FIG. 4A depicts, stun box simulator 400 includes receiver 402 mounted on floor 407 between side walls 408A and 408B connected by crossbar 405B. Stun box simulator 400 further includes angle iron 428 mechanically secured toward the front of receiver 402 and angle irons 426A and 426B mechanically secured toward the rear of receiver 402 with connecting plate 427 mechanically secured between angle irons 426A and 426B. Stun box simulator 400 also includes eyelet 429 mechanically secured to receiver 402.

As FIG. 4A also depicts, stun box simulator 400 includes front piston 443 (e.g., a pneumatic or hydraulic piston) mounted on floor 407 and mechanically connected toward the front of receiver 402. Stun box simulator 400 further includes side piston 442 (e.g., a pneumatic or hydraulic piston) connected to piston holder 451 and mounted on piston support plate 454 which is connected to side wall 408A.

FIG. 4A further depicts stun box simulator 400 includes springs 453A and 453B. Spring 453A is mechanically connected at one end to eyelet 452A on side wall 408A and at another end to an eyelet toward the rear of receiver 402. Similarly, spring 453B is mechanically connected at one end to eyelet 452B on side wall 408B and at another end to another eyelet toward the rear of receiver 402. FIG. 4A also depicts stun box simulator 400 includes vertical support 470 and a hoist on top of vertical support 470 from which a captive bolt instrument can be hung.

Turning to FIG. 4B, an example view of the rear of the stun box simulator of FIG. 4A is depicted. More specifically, as FIG. 4B depicts, stun box simulator 400 includes slide 406 that is vertically slidable on a post mounted to floor 407 between side walls 408A and 408B. FIG. 4B also depicts coupler 403 includes a ball socket attached to a ball on the top of slide 406. Furthermore, coupler 403 is mechanically connected to receiver 402. Coupler 403 can also include threaded connected 422A. FIG. 4B further depicts stun box simulator 400 includes angle irons 426A and 426B, connecting plate 427, and angle iron 428 as previously described.

As FIG. 4B also depicts, stun box simulator 400 includes side piston 442 (e.g., a pneumatic piston) connected to piston holder 451. Stun box simulator 400 also includes plate 462 which extends perpendicularly from and is mechanically secured (e.g., welded) to slide 406. Plate 462 provides a surface for side piston 442 to interact against.

Furthermore, FIG. 4B depicts stun box simulator 400 includes eyelet tabs 444A and 444B mechanically secured toward the rear of receiver 402, as well as eyelets 424A and 424B. Accordingly, as previously described, springs 453A and 453B are connected at one end to eyelets 452A and 452B on side walls 408A and 408B and at another end to eyelets 424A and 424B, respectively.

Regarding FIG. 4C, an example view of the front of the stun box simulator of FIG. 4A with the addition of a cow head is depicted. In particular, FIG. 4C depicts stun box simulator 400 includes cow head 401 mounted on receiver 402. Receiver 402 is connected to front piston 443 and springs 453A and 453B. Springs 453A and 453B are connected at one end to side walls 408A and 408B, respectively. Stun box simulator 400 further includes vertical support 470 mounted on floor 407 between side walls 408A and 408B. Vertical support 470 can be used to hang a captive bolt instrument which can be used to learn and practice effective stunning of an animal on cow head 401.

Thus, FIGS. 4A-4C depict that in the stun box simulator 400, one or more pistons can be actuated to move receiver 402 and in turn cow head 401 when mounted on receiver 402. More specifically, FIGS. 4A-4C depict that front piston 443 is mechanically connected to the front of receiver 402 and can be actuated to vertically move the front of receiver 402. In a similar fashion, a rear piston (not shown) is mechanically connected to slide 406 and can be actuated to vertically move slide 406, which in turn vertically moves coupler 403 and the rear of receiver 402. Additionally, side piston 442 is connected to side wall 408A and arranged to horizontally move receiver 402, coupler 403, and slide 406 by striking plate 462 that is mechanically secured to slide 406. FIGS. 4A-4C further depict springs 453A and 453B connected to receiver 402 and side walls 408A and 408B, respectively. Accordingly, springs 453A and 453B can store and release mechanical energy to move receiver 402 in unpredictable ways approximating the movements of a live animal, such as by vibrating, wobbling, or shaking.

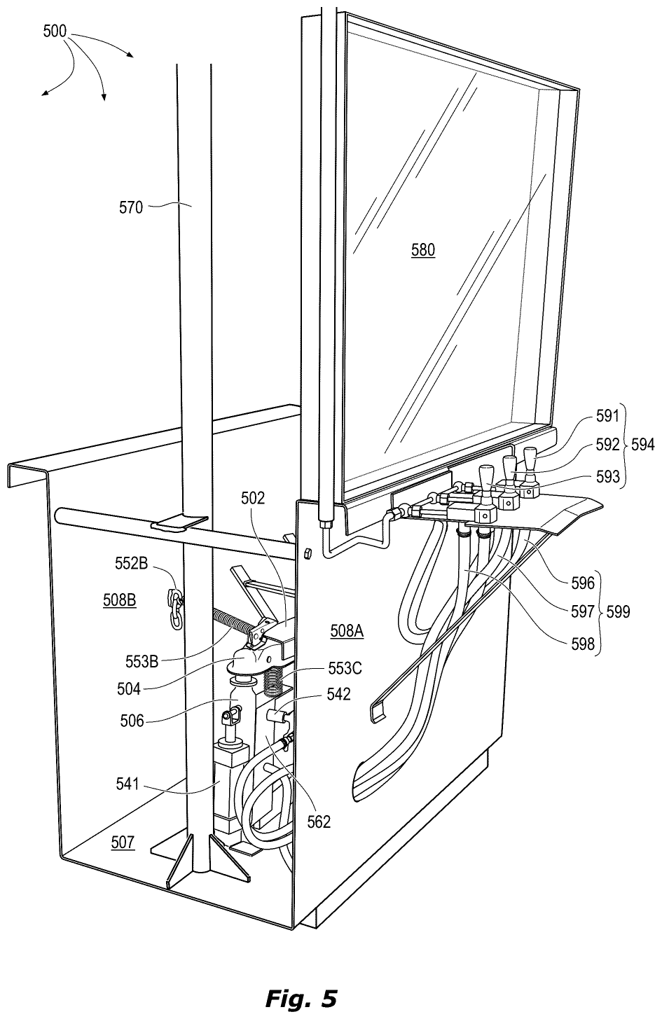

FIG. 5 depicts an example view of the rear of a stun box simulator 500 having a control panel 594 and a window 580 in accordance with one or more implementations. In particular, FIG. 5 depicts stun box simulator 500 includes control panel 594 (e.g., one or more joysticks controlling pneumatic valves) connected by control lines 599 to actuate one or more pistons, such as rear piston 541. More specifically, control panel 594 includes controls 591, 592, and 593 (e.g., joysticks or foot pedals for pneumatic valves) connected to front piston (not shown), rear piston 541, and side piston 542, respectively, by control lines 599 which includes control line 596, 597, and 598, respectively. For example, control 591 is connected to front piston (not shown) by control line 596. Likewise, control 592 is connected to side piston 542 by control line 597 and control 593 is connected to rear piston 541 by control line 598. Accordingly, FIG. 5 depicts that control 593 can be used to actuate rear piston 541 to vertically move slide 506, coupler 504, and receiver 502. Along similar lines, control 592 can be used to actuate side piston 542 to strike plate 562 to horizontally move slide 506, coupler 504, and receiver 502.

FIG. 5 further depicts stun box simulator 500 includes springs connected between receiver 502 and side walls 508A and 508B, such as spring 553B connected to wall 508B at eyelet 552B, as well as a spring underneath receiver 502 and coupler 504, namely spring 553C. Accordingly, when one or more of front piston (not shown), rear piston 541, and side piston 542 are actuated, mechanical energy is introduced into stun box simulator 500 such that springs 553B or 553C can store and release that energy, thereby causing receiver 502 and a cow head mounted thereon to vibrate, wobble, shake, or otherwise move unpredictably in a manner that approximates movements of a live animal in a production stun box.

FIG. 5 also depicts stun box simulator 500 includes vertical support 570 from which a captive bolt instrument can be hung. Additionally, stun box simulator 500 includes a window 580 connected to side wall 508A to protect an operator-trainer during operation of stun box simulator 500.

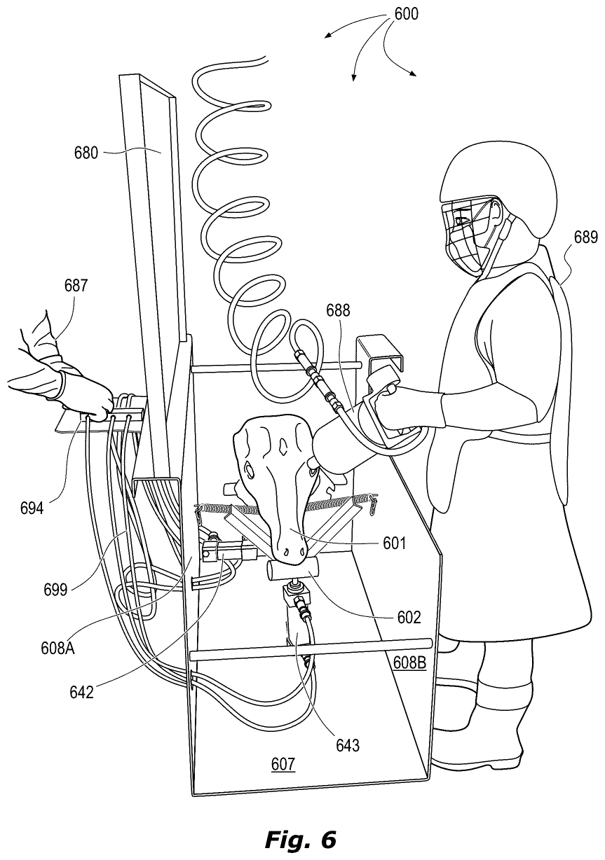

FIG. 6 depicts an example view of the front of a stun box simulator 600 operated by an operator-trainer 687 and used by a user-trainee 689 employing a captive bolt instrument 688 on a mounted cow head 601. FIG. 6 further depicts that stun box simulator 600 includes receiver 602 positioned between side walls 608A and 608B and upon which cow head 601 is mounted. FIG. 6 also depicts front piston 643 mounted on floor 607 and side piston 642 mounted on side wall 608A, both of which are connected to control panel 694 by control lines 699. Thus, at least one of front piston 643 and side piston 642 can be actuated to move cow head 601. More specifically, operator-trainer 687 can use control panel 694 to actuate at least one of front piston 643 and side piston 642 and thereby move cow head 601. Accordingly, while cow head 601 is moving, user-trainee 689 can learn and practice how to properly stun an animal by attempting to strike cow head 601 with captive bolt instrument 688.

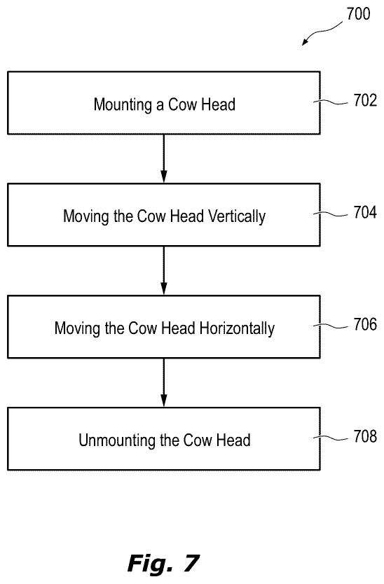

FIGS. 1-6, the corresponding text, and the examples provide a number of different systems and devices for simulating a production stun box. In addition to the foregoing, implementations can also be described in terms of flowcharts comprising acts and steps in a method for accomplishing a particular result. For example, FIG. 7, as described in further detail below, depicts a flowchart of an exemplary method in accordance with one or more implementations.

FIG. 7 depicts a flowchart of a series of acts in a method 700 of simulating a production stun box in accordance with one or more implementations. The method 700 includes an act 702 of mounting a cow head. More specifically, act 702 includes attaching the cow head to a receiver. For example, act 702 can include using a strap to attach the cow head to the receiver. Additionally or alternatively, act 702 can include sliding the cow head onto a receiver post. Once the cow head is mounted, it can then be used by a user-trainee to learn and practice how to effectively stun an animal with a captive bolt instrument.

Moreover, the method 700 includes an act 704 of moving the cow head vertically. In particular, act 704 includes actuating a piston to move the cow head vertically. For example, act 704 can include actuating a rear piston mechanically connected to a slide to vertically move a receiver upon which the cow head is mounted. Additionally or alternatively, act 704 can include actuating a front piston mechanically connected to a receiver to vertically move the receiver upon which the cow head is mounted. Also, act 704 can include controlling one or more pistons, using a computing device, to move the cow head vertically, wherein the computing device is controlled by one of a human operator-trainer or a computer program. Act 704 of moving the cow head vertically can be used to, at least in part, approximate the movements of a live animal in a production stun box.

Furthermore, the method 700 includes an act 706 of moving the cow head horizontally. More specifically, act 706 includes actuating a piston to move the cow head horizontally. For example, act 706 can include actuating a side piston to interact against a plate mechanically secured to a slide. As another example, act 706 can include actuating a side piston mechanically connected to a slide to rotate the slide and thereby move the cow head rotationally on a horizontal plane, such as around the vertical axis of the slide. Also, act 706 can include controlling one or more pistons, using a computing device, to move the cow head horizontally, wherein the computing device is controlled by one of a human operator-trainer or a computer program. Act 706 of moving the cow head horizontally can be used to, at least in part, approximate the movements of a live animal in a production stun box.

Additionally, the method 700 includes an act 708 of unmounting the cow head. In particular, act 708 includes detaching the cow head from a receiver. For example, act 708 can include removing a strap used to attach the cow head to the receiver and removing the cow head from atop the receiver. Additionally or alternatively, act 708 can include sliding the cow head off a receiver post. Once the cow head is unmounted, it can then be replaced with a new cow head to continue to learn and practice how to effectively stun an animal with a captive bolt instrument.

As described, some implementations can be controlled by a computer system or computing device. Accordingly, implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (SSDs) (e.g., RAM-based or flash-based), Shingled Magnetic Recording (SMR) devices, flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a NIC), and then eventually transferred to computer system RAM and/or to less volatile computer storage media (devices) at a computer system. Thus, computer storage media (devices) can be included in computer system components that also (or even primarily) utilize transmission media.

Computer-executable instructions comprise, for example, instructions and data which, in response to execution at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein for purposes of illustration, and are not intended to be limiting. Implementations of the present disclosure may be implemented in further types of devices.

The described aspects can also be implemented in cloud computing environments. In this description and the following claims, cloud computing is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (SaaS), Platform as a Service (PaaS), and Infrastructure as a Service (IaaS). A cloud computing model can also be deployed using different deployment models such as private cloud, community cloud, public cloud, hybrid cloud, and so forth. In this description and in the following claims, a cloud computing environment is an environment in which cloud computing is employed.

Components of the invention can be connected to (or be part of) a network, such as, for example, a system bus, a Local Area Network (LAN), a Wide Area Network (WAN), and even the Internet. Accordingly, computer systems, mobile phones, projectors, (articulator) controllers, articulators, steel targets, impact detectors, wireless relays, wearable shot detectors, game controllers, smart hearing protectors, smart safety glasses, cameras, websites, live scoring displays, management consoles, etc. as well as components thereof and any other connected computer systems and their components can create and exchange data (e.g., Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), Simple Object Access Protocol (SOAP), etc. or using other non-datagram protocols) over the network.

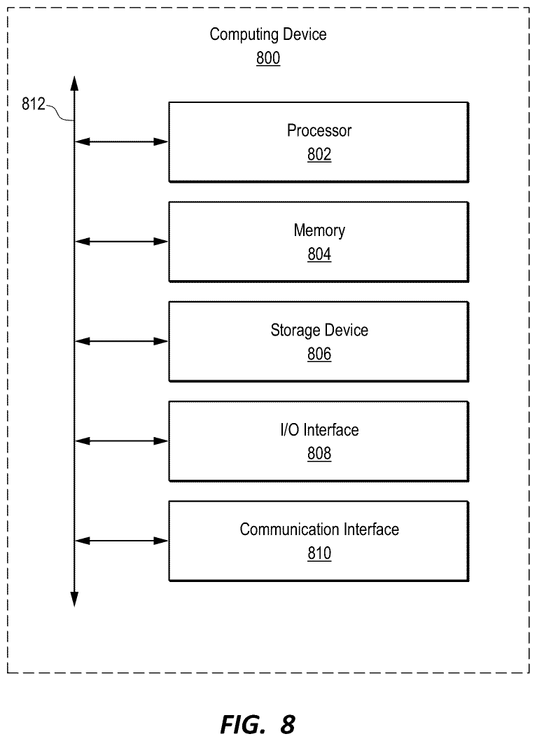

FIG. 8 depicts, in block diagram form, an exemplary computing device 800 that may be configured to perform one or more of the processes described above. For example, control panel 594 and controls 591, 592, and 593 of FIG. 5 can include implementations of computing device 800. As another example, control panel 694 of FIG. 6 can include implementations of computing device 800.

As depicted by FIG. 8, the computing device can comprise a processor 802, memory 804, a storage device 806, an I/O interface 808, and a communication interface 810. While an exemplary computing device 800 is depicted in FIG. 8, the components depicted in FIG. 8 are not intended to be limiting. Additional or alternative components may be used in other implementations. Furthermore, in certain implementations, a computing device 800 can include fewer components than those depicted in FIG. 8. Components of computing device 800 depicted in FIG. 8 will now be described in additional detail.

In particular implementations, processor(s) 802 includes hardware for executing instructions, such as those making up a computer program. As an example and not by way of limitation, to execute instructions, processor(s) 802 may retrieve (or fetch) the instructions from an internal register, an internal cache, memory 804, or a storage device 806 and decode and execute them. In particular implementations, processor(s) 802 may include one or more internal caches for data, instructions, or addresses. As an example and not by way of limitation, processor(s) 802 may include one or more instruction caches, one or more data caches, and one or more translation lookaside buffers (TLBs). Instructions in the instruction caches may be copies of instructions in memory 804 or storage device 806.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (RAM), Read Only Memory (ROM), a Solid-State Disk (SSD), flash, Phase Change Memory (PCM), or other types of data storage. The memory 804 may be internal or distributed memory.

The computing device 800 includes a storage device 806 for storing data or instructions. As an example and not by way of limitation, storage device 806 can comprise a non-transitory storage medium described above. The storage device 806 may include a hard disk drive (HDD), a floppy disk drive, flash memory, an optical disc, a magneto-optical disc, magnetic tape, or a Universal Serial Bus (USB) drive or a combination of two or more of these. Storage device 806 may include removable or non-removable (or fixed) media, where appropriate. Storage device 806 may be internal or external to the computing device 800. In particular implementations, storage device 806 is non-volatile, solid-state memory. In particular implementations, storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory, or a combination of two or more of these.

The computing device 800 also includes one or more input or output (I/O) devices/interfaces 808, which are provided to allow a user to provide input to, receive output from, and otherwise transfer data to and from the computing device 800. These I/O devices/interfaces 808 may include a mouse, keypad or a keyboard, a touch screen, camera, optical scanner, network interface, modem, other known I/O devices or a combination of such I/O devices/interfaces 808. The touch screen may be activated with a stylus or a finger.

The I/O devices/interfaces 808 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O devices/interfaces 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device 800 and one or more other computing devices or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WIFI.

This disclosure contemplates any suitable network and any suitable communication interface 810. As an example and not by way of limitation, computing device 800 may communicate with an ad hoc network, a personal area network (PAN), a local area network (LAN), a wide area network (WAN), a metropolitan area network (MAN), or one or more portions of the Internet, or a combination of two or more of these. One or more portions of one or more of these networks may be wired or wireless. As an example, computing device 800 may communicate with a wireless PAN (WPAN) (such as, for example, a BLUETOOTH WPAN), a WIFI network, a WI-MAX network, a cellular telephone network (such as, for example, a Global System for Mobile Communications (GSM) network), or other suitable wireless network or a combination thereof. Computing device 800 may include any suitable communication interface 810 for any of these networks, where appropriate.

The computing device 800 can further include a bus 812. The bus 812 can comprise hardware, software, or both that couples components of computing device 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

Thus, the present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A stun box simulator, comprising:
a post;
a slide vertically slidable on the post, the slide including a ball on top;
a receiver;
a coupler mechanically connected to the receiver, the coupler including a ball socket attached to the ball; and
a cow head mounted on the receiver.

2. The stun box simulator of claim 1, further comprising a first piston mechanically connected to the slide.

3. The stun box simulator of claim 2, further comprising a second piston mechanically connected to the receiver.

4. The stun box simulator of claim 3, further comprising:
a plate mechanically secured to the slide; and
a spring on the plate, the spring mechanically attached to the receiver.

5. The stun box simulator of claim 1, further comprising:
a floor;
a first side wall; and
a second side wall;
wherein the post is mounted to the floor.

6. The stun box simulator of claim 5, further comprising:
a plate mechanically secured to the slide; and
a first piston mounted to the first side wall to interact against the plate.

7. The stun box simulator of claim 6, further comprising:
a first spring connected to a side of the receiver and to the first side wall; and
a second spring connected to an opposing side of the receiver and to the second side wall.

8. The stun box simulator or claim 1, wherein the cow head is one of a real cow head or a prosthetic cow head.

9. A stun box simulator, comprising:
a floor;
a post mounted to the floor;
a slide vertically slidable on the post, the slide including a ball on top;
a receiver;
a coupler mechanically connected to the receiver, the coupler including a ball socket attached to the ball;
a cow head mounted on the receiver; and
a first piston mounted to the floor and mechanically connected to the slide.

10. The stun box simulator of claim 9, further comprising:
a first side wall;
a second side wall;
a first spring attached to one side of the receiver and to the first side wall; and
a second spring attached to an opposing side of the receiver and to the second side wall.

11. The stun box simulator of claim 9, further comprising:
a plate mechanically secured to the slide; and
a spring on the plate, the spring mechanically attached to the receiver.

12. The stun box simulator of claim 9, further comprising a pin on the slide, the pin extending toward the rear of the stun box simulator, the pin mechanically connected to the first piston.

13. The stun box simulator of claim 9, further comprising:
a pin on the receiver; and
a second piston mounted to the floor and mechanically connected to the pin.

14. The stun box simulator of claim 9, further comprising:
a side wall;
a second piston mounted to the side wall;
a plate on the slide, the plate extending toward the front of the stun box simulator, the plate mechanically connected to interact against the second piston.

15. The stun box simulator of claim 9, further comprising:
a side wall perpendicular to the floor;
a second piston mounted to the floor and mechanically connected to the receiver;
a third piston mounted to the side wall and mechanically connected to the slide; and
a control panel connected to each of the first piston, the second piston, and the third piston.

16. The stun box simulator of claim 15, wherein the control panel includes at least one of a foot pedal or a joystick.

17. The stun box simulator of claim 15, wherein the first piston, the second piston. and the third piston are selected from among pneumatic pistons or hydraulic pistons.

18. A method of simulating a production stun box comprising:
mounting a cow head;
moving the cow head vertically; and
moving the cow head horizontally.

19. The method of claim 18, wherein moving the cow head vertically comprises:
moving a rear portion of the cow head vertically along a first axis; and
moving a front portion of the cow head vertically along a second axis.

20. The method of claim 18, wherein moving the cow head horizontally comprises rotating the cow head about an axis.
